(19) United States
(12) Patent Application Publication
(10) Pub. No.: US 2008/0048590 A1
(43) Pub. Date: Feb. 28, 2008

(54) Voltage Regulator

(75) Inventor: Malkiel Hagbi, Emek Hefer (IL)

Correspondence Address: PEARL COHEN ZEDEK LATZER, LLP, 1500 BROADWAY 12TH FLOOR, NEW YORK, NY, 10036, US

(73) Assignee: S.M. UNIVERSE ELECTRONICS LTD., Emek Hefer (IL)

(21) Appl. No.: 11/632,532

(22) PCT Filed: Jul. 21, 2005
(86) PCT No.: PCT/IL05/00780

§ 371 Date: Jan. 17, 2007

(30) Foreign Application Priority Data
Jul. 26, 2004 (IL) 163211

(51) Int. Cl. G05F 1/00; H05B 39/04

(52) U.S. Cl. 315/360

(57) ABSTRACT

The present invention relates to control of a power supply for a lamps circuit. More particularly, the invention provides a power-saving voltage controller intended for fluorescent and incandescent lamps and is particularly useful for controlling high-intensity discharge (HID) lamps. The invention comprising a multi-mode switch-based AC voltage regulator with feedback, the voltage regulator providing full power for lamp start up and reduced voltage for normal operation and a programmed electronic controller operatively connected to all control switches and measurement devices.

### FIELD AND BACKGROUND OF THE INVENTION

The present invention relates to control of a power supply for a lamps circuit.

More particularly, the invention provides a power-saving voltage controller intended for fluorescent and incandescent lamps and is particularly useful for controlling high-intensity discharge (HID) lamps.

HID lamps include lamps based on mercury, high-pressure sodium or metal halide, and as fluorescent lamps usually require a choke (ballast), a capacitor and an ignition unit. HID lamps are used extensively in street lighting, malls, hotels, offices and for illumination of large open areas. While the first cost of the lamp and its ballast is high, users are more than compensated by the high ratio of luminance per watt and additionally by a lamp operating life which may extend well beyond 24000 hours for the high pressure sodium lamp and 10,000 hours for the metal halide lamp, greatly reducing maintenance costs in comparison with normal fluorescent or incandescent lighting.

As HID lamps are used in large numbers, typically for street lighting, it is well worthwhile to take whatever action is possible to reduce the consumption of electricity therein. A key tool for achieving this end is to regulate the voltage supplied to the lamp.

It has long been known that reducing the running voltage applied to an operating HID lamp will save enough electric power to justify the installation of special equipment designed for this purpose. Voltage supplied to HID lamps can however only be reduced after the lamps are in operation at nominal voltage for at least 15 minutes and it is essential in order to allow the lamp to establish an arc in the starting mode. Thereafter voltage can be reduced in accordance with ambient lighting and changed usage conditions, within the limits set by the lamp manufacturer and for example, the ramp-down speed of the lamp voltage must be 5 volt per second, the decreasing power must be stable against the variations of the supply voltage and/or against the variations of the load (lamps), all the voltage regulation and stabilization process must be perform linear with no transits voltage and with no lighting line disconnection. Any scheme for voltage control must take into account the ballast in the lamp circuit, which eliminates the possibility of using low-cost dimming devices such as are used for incandescent lamps. Furthermore voltage should not be decreased to a level below that specified by the manufacturer, as the desired long lamp life is endangered by operation at any voltage outside the low/high limits specified by the manufacturer. Normal line voltage can vary as much as ±10%, and merely by stabilizing the voltage received by the lamp significant power savings are already attainable. As is known in the prior art, additional power savings are achieved by reducing voltage to the lamp after start up.

Voltage controllers for motors and other appliances are disclosed in U.S. Pat. Nos. 4,160,202 4,408,268 4,435,677 4,630,220 5,329,223 5,612,645 5,777,508 and 5,932,981. Two patent applications US2001/0023678A1 and US2003/00073000A1 also relate to voltage controllers. However as the present invention relates to the specific requirements of lighting fixtures, the state of the art in this field will be discussed herein.

In U.S. Pat. No. 4,513,224 Thomas discloses a voltage controller for fluorescent lighting. The system provides for full and for reduced voltages, but requires a 3-phase transformer and four contactors. The bulk and cost of the system would be suitable for installation in a suitably-sized casing in a building but would be difficult to add to a normal street light.

Crawford in U.S. Pat. No. 4,740,731 proposes a two capacitor apparatus for sequential starting and operation of multiple series connected discharge lamps. The apparatus includes a transformer with one primary winding and two secondary windings. The capacitors are used to prevent flow of DC current through the lamps. Superior operating characteristics are claimed but it is unclear how closely voltage can be stabilized without feedback control.

The most recent relevant document found by the present inventors which refers specifically to a power-saving voltage reduction system for HID lamps is U.S. Pat. No. 5,508,589 to Archdekin. Claim 1 reads as follows:

In combination with a street light having a lamp structure with a receptacle receiving an ambient light sensor for automatically activating the light, a voltage reduction apparatus interposed between said light sensor and said lamp structure and comprising
a receptacle receiving said light sensor;
a plug mating said apparatus and said light sensor with said lamp structure receptacle; and
means for reducing the voltage applied to said light upon said automatic activation to a level below line voltage after a selected period of time;
wherein said voltage reduction means comprises an autotransformer having a series winding and a common winding, said series winding being connected at its input to said line voltage and at its output to said light; said common winding being selectively connected between said output of said series winding and common for reducing the voltage applied to said light.

The Archdekin patent makes no provision for feedback, which is however necessary to cope with variations in input voltage if accurate output is desired. Using autotransformers causes the output voltage to vary in proportion to input voltage. This arrangement is satisfactory if the line voltage is in itself stable; however line voltage can and does vary up to about 6%-10%. The use of coil transformers as is seen in most prior art voltage controllers also means that output voltages are available only at the pre-selected points where terminal connections are provided; see for example U.S. Pat. No. 4,219,759 to Hirschfeld. A further disadvantage of controllers based on coil transformers lies in the bulk of the coils—making the voltage controller difficult or impossible to fit into the space available inside a streetlight.

### OBJECTS OF THE INVENTION

It is therefore one of the objects of the present invention to obviate the disadvantages of prior art voltage controllers and to provide a circuit which provides close output control even during substantial variations of input (line) voltage and/or during variations of the load (lamps).

It is a further object of the present invention to provide a controller of reduced bulk, and of lower cost than has hitherto been possible.

Yet a further object of the invention is to provide a controller able to dispose of unwanted inductive charges generated during operation.

Yet a further object of the invention is to reduce the supplied voltage only after warming time of 15 minutes at nominal voltage for every start or restart, and the voltage reduction perform slowly linear, at a rate of about 5 volts per minute, with no transits voltage and with no lighting line disconnection. According to the lamp manufacturer's specifications, fast voltage change is detrimental to the life expectancy of the lamp. However fast voltage change is likely when using coils with fixed position taps, substantially reducing the operating life of the lamp.

Yet a further object of the invention is to maintain the reduced voltage within an accuracy of ±1% above the minimum allowed voltage even under conditions of variations in the supply voltage and/or variations of the load (lamps).

### SUMMARY OF THE INVENTION

The present invention achieves the above objects by providing a multi-mode switch-based AC voltage regulator with feedback, particularly useful for the control of a lighting circuit including high-intensity discharge (HID) lamps, fluorescent lamps and incandescent lamps, said voltage regulator providing full power for lamp start up and reduced voltage for normal operation, said voltage regulator comprising
an input pair of terminals (P, N) connectable to a line voltage power supply;
an output pair of terminals (PR, N₂) connectable to said lighting circuit;
a connection between terminals N and N₂;
a connection between terminals P and PR, said connection being interrupted by synchronous switches (S1, S2) wired in series, said switches being arranged to open and close during a part of the AC positive wave and during a part of the AC negative wave;
an output voltage measurement device operatively connected between said output pair of terminals (PR, N₂);
and
a programmed electronic controller operatively connected to all control switches and measurement devices, and controlling the time said control switches are open and closed,

Whereby output voltage is regulated by adjustment of the time said switches are open and any capacitive component of the load is discharged by the load through said regulator into the line supply.

In a further preferred embodiment of the present invention there is provided an AC voltage regulator further being arranged to supply also a load having an inductive component and where the voltage to be supplied is lower than the line voltage, said regulator being provided with a connection between terminals N₂ and PR, said connection being interrupted by a third and a fourth synchronous switch (S3,S4) normally open and wired in series, said third and a fourth synchronous switch (S3,S4) being arranged to close only during the period when synchronous switches (S1, S2) are open, allowing discharge of inductive energy in the load through said connection between terminals N₂ and PR while avoiding short-circuiting the supply line.

In a most preferred embodiment of the present invention there is provided an

Yet further embodiments of the invention will be described hereinafter.

It will thus be realized that the novel device of the present invention provides a low-bulk voltage controller which can be inserted inside a lighting facilities. This however does not limit the controller to servicing only a single lamp. A controller made according to the present invention is compact enough to serve several lamps. Where the controller is designed to serve a large number of lamps it will have a large current capacity and will be housed in its own enclosure at a local control facility.

Provision of a light-measuring sensor makes possible the automatic dimming of lamps by supplied voltage reduction where natural light is available. When the required light level is maintained for a few minutes the voltage is cut off totally on the assumption that such light originates from daybreak and not from the headlights of a road vehicle(s).

Provision of a motion detecting sensor makes possible the automatic dimming or even extinction of lamps by supplied voltage reduction where there is no need for full lighting due to the absence of traffic.

The circuit disclosed in the present invention operates by cutting off power to the load by means of switches. This results in a voltage controller able to handle in any combination with resistive electrical loads and/or with electrical capacitor loads (power factor −0.4) and/or with inductive loads (power factor +0.4). In operation the controller operates at about 99% efficiency and provides ±1% voltage regulation.

In the RMS Voltage controller disclosed by Thomas in U.S. Pat. No. 4,435,677 the load can be interrupted for several cycles, which can cause extinguishing the arc and/or flickering. Mercury vapor lamps are particularly sensitive to such power interruption, as are high pressure sodium and metal halide lamps. The sudden shut-down of one or more street lights can confuse motorists and cause a road accident.

However in contradistinction thereto in the present invention the load is not interrupted for longer than about 0.3 of a cycle, which obviates these problems.

The present invention also provides means to handle inductive loads resulting from operation of the switches S1 and S2. This is achieved by interconnecting the terminals PR and N through a further pair of synchronous switches S3 and S4, also under the control of the programmed electronic controller. Thus the controller of the present invention is able to handle resistive, inductive and capacitor loads separately or in combination. The ability of the voltage controller of the present invention to handle capacitive loads is particularly important when applied to HID lamps lights, where capacitors are often installed in an effort to improve the power factor.

### SHORT DESCRIPTION OF THE DRAWINGS

The invention will now be described further with reference to the accompanying drawings, which represent by example preferred embodiments of the invention. Structural details are shown only as far as necessary for a fundamental understanding thereof. The described examples, together with the drawings, will make apparent to those skilled in the art how further forms of the invention may be realized.

In the drawings:

FIG. 1 is a diagram of a preferred embodiment of the voltage controller according to the invention;

FIG. 2 is a is a diagram of a preferred embodiment of the voltage controller further provided with a current measuring device;

FIG. 3 is a is a diagram of a preferred embodiment of the voltage controller arranged to release inductive charges;

FIG. 4 is a diagram of a preferred embodiment of the voltage controller further provided with a light sensor;

and

FIG. 5 is a diagram of a preferred embodiment of the voltage controller further provided with a movement sensor;

### FULL DESCRIPTION OF THE INVENTION

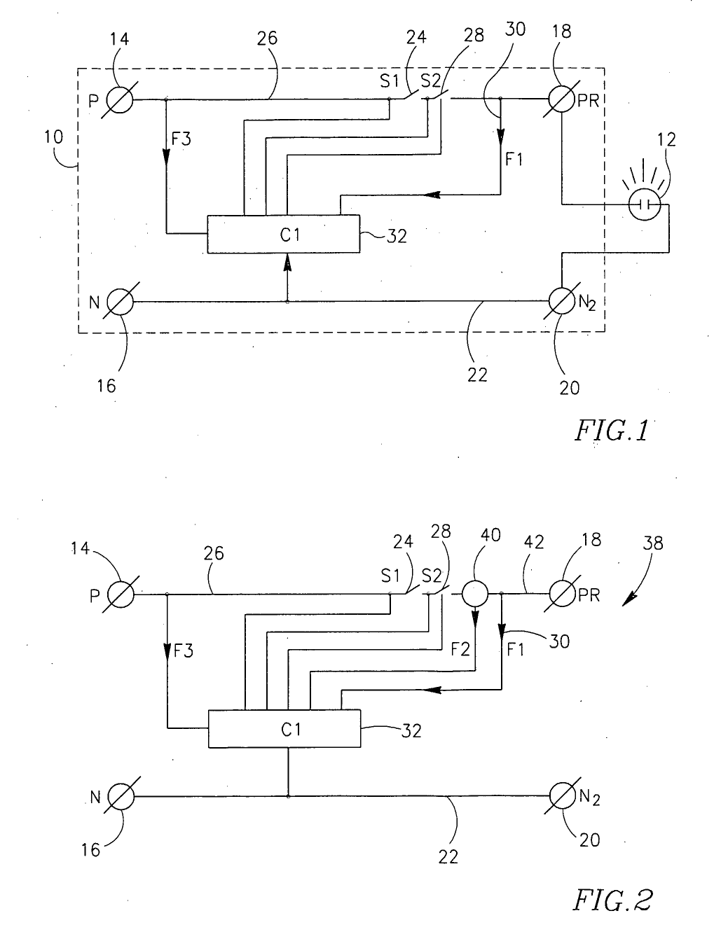

There is seen in FIG. 1 a switch-based AC voltage controller 10 with feedback for the control of at least one high-intensity discharge (HID) lamp 12. The controller 10 provides full power for lamp start up and reduced voltage for normal operation.

An input pair of terminals (P, N) 14, 16 are connectable to a single phase AC line voltage power supply; in Israel and Europe 230V 50 hz, in the US 110/115 volt 60 hz or 220/240/277 volt 60 hz.

A pair of output terminals (PR, N₂) 18, 20 are connected in parallel to several lamps 12, only one of which is shown in the diagram.

The neutral phase 22 passes between terminals N and N₂ 16, 20.

The connection 26 between terminals P and PR 14,18 is interrupted by a first and a second synchronous switch (S1, S2) 24, 28 wired in series. The first switch 24 is arranged to closed (ON) during the positive part of the AC wave, and the second switch 28 is arranged to closed (ON) during the negative part of the AC wave.

Each switch preferably comprises a MOSFET (Metal Oxide Semiconductor Field Effect Transistor)

An output voltage measurement circuit F1 30 is operatively connected between the output pair of terminals (PR, N₂) 18, 20. In the diagram the connection passes through a programmed electronic controller C1 32, which is a micro-processor operatively connected to receive information from the output line and measurement devices. The programmed electronic controller C1 32 calculates when and for how long all switches, including those to be described in further embodiments, are to be opened and closed, and supplies the needed signals, and power, through connectors 18, 20, to operate the switches The output voltage supplied at the terminals (PR, N₂) 18, 20 is controlled by a program in the electronic controller C1 32, which commands the time and opening/closing of the synchronous switches (S1, S2) 24, 28 as needed.

In operation the voltage controller 10 maintains output voltage within ±1% while input voltage varies ±10%. During start up both synchronous switches (S1, S2) 24, 28 are closed (ON) and allow full power flow to the lamp 12.

The voltage controller 10 operates at an efficiency of about 99%.

With reference to the rest of the figures, similar reference numerals have been used to identify similar parts.

Referring now to FIG. 2, there is seen an AC voltage controller 38 further provided with a current measuring device F2 40. Current data generated by the device 40 is passed to the electronic controller C1 32. The device 40 is installed in a connection 42 between the input terminal P 14 and the switches 24 and 28.

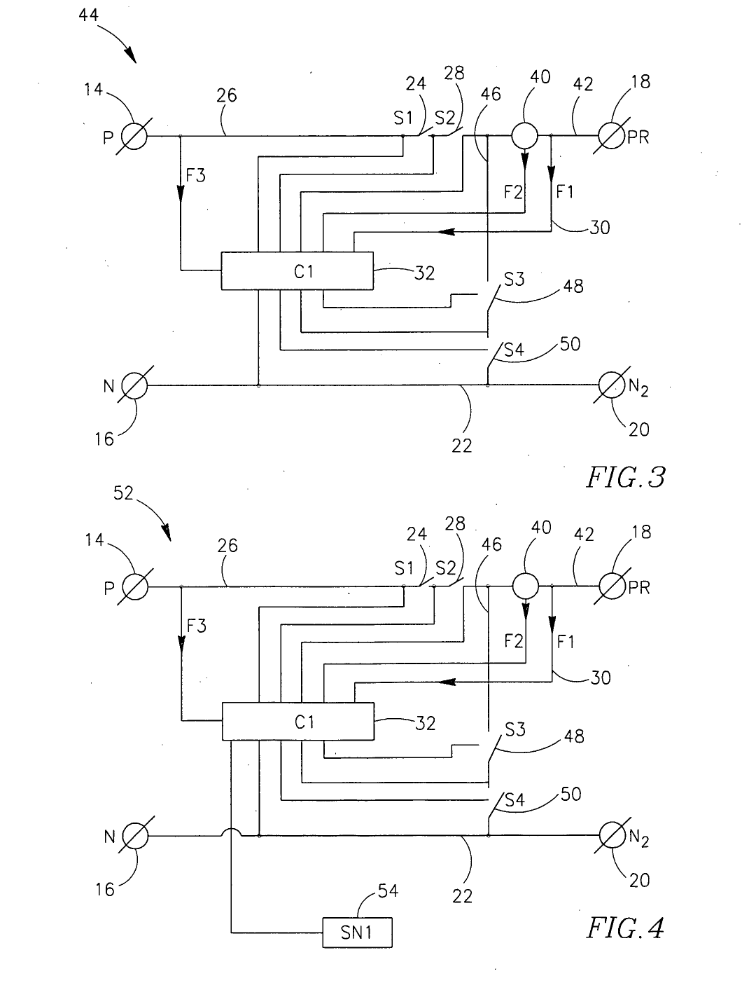

FIG. 3 illustrates an embodiment of the AC voltage controller 44 further provided with a connection 46 between terminals N₂ and PR. The connection 46 is interrupted by a third 48 and a fourth synchronous switch 50. The switches 48, 50 are marked S3 and S4 wired in series.

The third switch 48 is arranged to close (ON) during a part of the negative or positive portion dependence on the energy polarity of the inductive load.

The fourth switch 50 is arranged to close (ON) during a part of the negative or positive portion dependence on the energy polarity of the inductive load.

The switches 48, 50 are marked S3 and S4 functions are to discharge the inductive energy charged in the load after operation of switches S1 and S2 respectively.

Seen in FIG. 4 is an embodiment of the AC voltage controller 52 further provided with a connection to a light sensor marked SN1 54. The sensor conveys signals generated from measurement of the ambient illumination level to the electronic controller C1 32.

Aside from its obvious use in distinguishing between day and night the light sensor 54 also responds to the diminishing light output of the lamp as same ages, thus causing some reduction in voltage when the lamp is new.

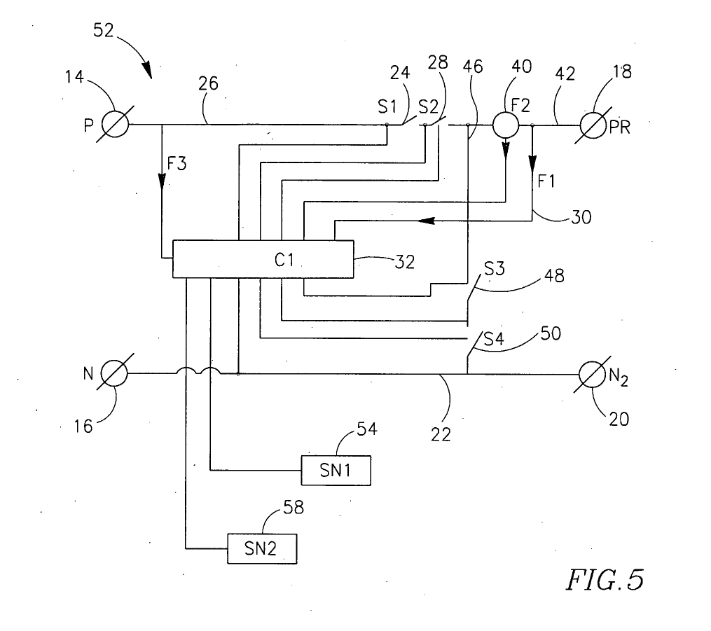

Referring now to FIG. 5, there is depicted one more AC voltage controller 56 further provided with a connection for an optional movement sensor 58. The sensor 58 conveys signals generated by detecting moving vehicles and pedestrians, to the programmed electronic controller C1 32, which responds by reducing or stopping the voltage supplied to lamp 12.

The scope of the described invention is intended to include all embodiments coming within the meaning of the following claims. The foregoing examples illustrate useful forms of the invention, but are not to be considered as limiting its scope, as those skilled in the art will be aware that additional variants and modifications of the invention can readily be formulated without departing from the meaning of the following claims.

We claim:

1. A multi-mode switch-based AC voltage regulator with feedback, particularly useful for the control of a lighting circuit including high-intensity discharge (HID) lamps, fluorescent lamps and incandescent lamps, said voltage regulator providing full power for lamp start up for 1 up to 20 minutes (adjustable according to the lamp type) and reduced the output voltage slowly linear, at a rate of 1 up to 15 volts per minute (adjustable according to the lamp type), with no transits voltage and with no lighting line disconnection, to the requested voltage operation, said voltage regulator comprising
an input pair of terminals (P, N) connectable to a line voltage power supply;
an output pair of terminals (PR, N₂) connectable to said lighting circuit;
a connection between terminals N and N₂;
a connection between terminals P and PR, said connection being interrupted by synchronous switches (S1, S2) wired in series, said switches being arranged to open and close during the AC positive wave and during the AC negative wave and during a part of the time for discharging the energy of inductive or capacitive load;
an output voltage measurement device operatively connected between said output pair of terminals (PR, N₂); and
a programmed electronic controller operatively connected to all control switches and measurement devices, and controlling the timing of said control switches are open and closed, Whereby output voltage is regulated by adjustment of the timing of said switches are ON/OFF in any capacitive or inductive component of the load is discharged through the said switches into the line supply.

2. The AC voltage regulator as claimed in claim 1, further provided with a current sensing device installed in a connection between one of said output pair of terminals and the corresponding input terminal, the result of said reading being transferred to said programmed electronic controller.

3. The AC voltage regulator as claimed in claim 1 further being arranged to supply also a load having an inductive component and where the voltage to be supplied is equal to the line voltage, said programmed electronic controller being arranged to open and close said synchronous switches (S1, S2), during which time allowing the discharge of said inductive component in the direction from the load to the line supply through switches S1, S2.

4. The AC voltage regulator as claimed in claim 1, further being arranged to supply also a load having an inductive component and where the voltage to be supplied is lower than the line voltage, said regulator being provided with a connection between terminals N₂ and PR, said connection being interrupted by a third and a fourth synchronous switch (S3,S4) normally open (OFF) and wired in series, said third and a fourth synchronous switch (S3,S4) being arranged to close (ON) only during the period when synchronous switches (S1, S2) are open (OFF), allowing discharge of inductive energy in the load through said connection between terminals N₂ and PR while avoiding short-circuiting the supply line.

5. The AC voltage regulator as claimed in claim 1 further being arranged to supply also a load having an capacitive component and where the voltage to be supplied is equal to the line voltage or lower than the line voltage, said programmed electronic controller being arranged to open and close said synchronous switches (S1, S2), during which time allowing the discharge of said capacitive component in the direction from the load to the line supply through switches S1, S2.

6. The AC voltage regulator as claimed in claim 1, further provided with a connection to a light sensor arranged to convey signals generated from measurement of the ambient illumination level to said programmed electronic controller.

7. The AC voltage regulator as claimed in claim 1, further provided with a connection for an optional movement sensor arranged to convey signals generated by detecting moving vehicles and pedestrians, to said programmed electronic controller.

8. The AC voltage regulator as claimed in claim 1, wherein said switches are semi-conductors.

9. The AC voltage regulator as claimed in claim 1, wherein output voltage is stabilize and maintained within ±1% while input voltage varies ±10% and/or while the load varies from no load to full load.
